(19) United States
(12) Patent Application Publication
(10) Pub. No.: US 2009/0106193 A1
(43) Pub. Date: Apr. 23, 2009

(54) REAL TIME RESPONSES IN DECENTRALIZED NETWORKS

(75) Inventors: Marc Andre Peters, Eindhoven (NL); Wilhelmus Henrica Gerarda Maria Van Den Boomen, Eindhoven (NL); Alexander Borisovich Kobzhev, Eindhoven (NL); Dale Robert Heron, Crawley (GB); Alexis Stephen Richard Ashley, Redhill (GB)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/573,782

(22) PCT Filed: Aug. 18, 2005
(86) PCT No.: PCT/IB2005/052718

§ 371 Date: Nov. 10, 2008

(30) Foreign Application Priority Data
Aug. 20, 2004 (EP) 04104004.9

(51) Int. Cl. G06F 7/06; G06F 17/30

(52) U.S. Cl. 707/3; 707/E17.108

(57) ABSTRACT

A method of enabling a user to obtain a query result in a data network is provided taken latency problems of decentralised networks comprising a number of entities into account. The method comprises the steps of sending a query from a requesting entity to a number of further entities in the data network, receiving responses from at least some of the further entities and determining an initial relative response time for an initial group of said responses, determining a current relative response time for further incoming responses, comparing the initial relative response time with the current relative response time, and presenting the responses to a user of the requesting entity when the difference between the initial relative response time and the current relative response time exceeds a relative response-time parameter Further, a computer readable medium and a device provided with or for carrying out such methods are provided.

### FIELD OF INVENTION

The present invention relates to a method of obtaining or a method of enabling to obtain a query result in a data network, especially in a (fully or partly) decentralised network, and to a computer readable medium having instructions for causing a central processing unit to execute this method. The method takes the latency of the network system into account on acquiring information from entities of the network.

### BACKGROUND OF THE INVENTION

Until recently, a data network used to be a centralized network controlled by a primary server. The server handled all queries and requests from a user and provided a completed result of any query or request to the user.

However, the use of decentralized networks, such as peer-to-peer networks, or partly decentralized networks, comprising a number of entities, but not necessarily a server, has become more widespread in recent years. A query is then sent from one entity to another entity or to a number other entities, and the incoming results may be spread out in time, due to different speed of different pats of the network.

The built in latency of such networks then influences the result a user is presented with. If the query is a query for e.g. a specific song, a film, etc., the user is typically satisfied when one corresponding song or film is provided. However, when the query does not provide an exact match or if the query has more possible results, when e.g. inquering songs of a specific singer, the results may pop-up during a long period of time, and the results are then only ordered according to the time of receipt.

### SUMMARY OF THE INVENTION

It is an object of the present invention to provide a method of obtaining, or a method of enabling a user to obtain, a query result in a data network comprising a number of entities, the method comprises the steps of:
sending a query from a requesting entity to a number of further entities in the data network,
receiving responses from at least some of the number of further entities and determining an initial relative response time for an initial group of said responses,
determining a current relative response time for further incoming responses,
comparing the initial relative response time with the current relative response time, and
enabling to present the responses to a user of the requesting entity when the difference between the initial relative response time and the current relative response time exceeds a relative-response-time parameter (rate_change).

According to another aspect of the present invention, a method of providing a query response to a user is provided, wherein the user sends a request to a number of entities connected in an at least partly decentralized network, the method comprising:
receiving responses from at least some of the number of entities and determining an initial relative response time for a initial group of said responses,
determining a current relative response time for further incoming responses, comparing the initial relative response time with the current relative response time, and
enabling to present the responses to a user of the requesting entity when the difference between the initial relative response time and the current relative response time exceeds a relative-response-time parameter (rate_change).

The method of enabling a user to obtain, or the method of obtaining, a query result in a data network, or the method of providing a query response to a user, may be stored on a computer readable medium, so that the computer readable medium comprises or have stored therein instructions for causing a central processing unit to execute any of the said methods. In a preferred embodiment of the invention, the query is a search query.

The present invention allows a user sending a query in an at least partly decentralised network, to be presented with the responses when the latency of the requests increases, in the present case when the relative response time of the responses increases above a relative response time parameter. The relative response time is the latency of a subsequent response in relation to the previous response or in other words, the difference in time between two consecutive responses coming back to the requesting entity. It is an advantage that the user may receive a package of responses instead of a long range of separate responses. Furthermore, the processing of incoming results may be performed in the background of other programs or functions or the requesting entity so that the user is only interrupted when a certain amount of results has been accumulated.

The initial group of responses may comprise a number of the initial responses received at the requesting entity, e.g. the first 5 responses, the first 10, 20 or 30 responses, or any other appropriate number of responses. Alternatively, the initial group of responses may comprise the number of responses received at the requesting entity within an initial time interval, such as within the first 10 seconds, within the first 20, 30, 50 or 60 seconds. The number of responses to form the initial group, or the initial time interval may be a pre-set number or value or it may be a number or value provided by the user. Preferably, the number or value is selected to suit the specific network and/or the specific query.

Thus, the initial relative response time is in a preferred embodiment the average of the relative response times of the initial group of responses. It is envisaged that also other functions of the relative response times of the initial group may be used to provide an initial relative response time. By defining the relative response time in relation to a previous received response, it is clear that no relative response time can be determined for the very first received response, and thus having five responses in the initial group provides an initial response time determined on four relative response times.

The current relative response time is a dynamically determined relative response time which may be determined for each consecutive further response received or it may be determined for each group of further responses, thus for example as the average of each 3, 5, 7, or 10 further responses received at the requesting entity.

To obtain a measure of when to provide a result to a user on the basis of the initial relative response time and the current relative response time determined during the processing of the query, a relative-response-time parameter is provided. When a comparison between the initial relative response time and the current relative response time exceeds a relative-response-time parameter (rate_change), the results of the query presently received by the requesting entity is provided to the user. Using a comparison between the initial relative response time and the current relative response time as criteria, it is ensured that account is taken to the specific network, the specific query, etc. so that it is not a random decision of when to provide the results to a user. Hereby, the user may receive a thorough result within a minimum time. Furthermore, the relative-response-time parameter may be determined as a function of the initial relative response time. This further provides for an application specific presentation of the results to the user.

To ensure that a result is always presented to the user within a certain maximum time, the results may be provided to a user when a maximum time has lapsed irrespective of the current relative response time and thus also irrespective of the result of a comparison between the current relative response time and the initial relative response time. Hereby, it is ensured that no matter how slow the network is or how long time it takes between the different results to be received at the requesting entity, the user is always presented with at least some result after a maximum time, such as after 10 seconds, 30 seconds, 1 minute, 2 minutes, 5 minutes, etc. The maximum time may be a predefined parameter or it may be defined by a user of the requesting entity.

The data network may be a partly decentralized network, such a peer-to-peer network. In a preferred embodiment, the network is a network of enhanced televion sets, set-top boxes, personal video recorders.

It is an advantage of the present invention, that by providing the result of a query only after a certain number of results have been received, the results may be ordered according to a parameter before they are presented to the user, the results may e.g. be ordered alphabetically, according to relevance, etc. Thus, the random ordering of the results, when they are just provided to the user upon receipt may be avoided.

A refresh feature may be provided so that a user, when a first result has been provided to the user, may request that additional results received after the first results were provided to the user, are also presented. Thus, if a user has not found the desired result among the first results provided, the additional results, if any, may be presented by e.g. pressing a refresh button.

The additional results may be provided in the top of the list or in another font, so as to clearly indicate to the user which are the additional results.

Processing of the received results may be stopped upon receiving a stop signal from the user. The stop signal may be the initiation of a new query, the ending of the query session, etc.

According to a further aspect of the present invention, a data network comprising a number of entities is provided, wherein a query is sent from a requesting entity to a number of further entities in the network, and wherein responses from at least some of the number of further entities are provided to a processor of the requesting entity, the processor being adapted to receive the responses, and to
determine an initial relative response time for an initial group of said responses,
determine a current relative response time for further incoming responses,
compare the initial relative response time with the current relative response time, and provide the responses to a user interface means of the requesting entity for presentation of the results when the difference between the initial relative response time and the relative response time exceeds a relative-response-time parameter (rate_change).

A further aspect of the present invention comprises a device for use in a method of enabling a user to obtain a query result in a data network comprising a number of entities, wherein:

the method comprises the steps of:
sending a query from a requesting entity to a number of further entities in the data network,
receiving responses from at least some of the number of further entities and determining an initial relative response time for an initial group of said responses,
determining a current relative response time for further incoming responses, comparing the initial relative response time with the current relative response time, and
enabling to present the responses to a user of the requesting entity when the difference between the initial relative response time and the current relative response time exceeds a relative-response-time parameter (rate_change), and the device comprises:
a requesting entity comprising a processor,
a number of further entities, the requesting entity and the number of further entities are arranged for connecting in a network, and
a user interface means for presenting the responses to the user.

It is envisaged that all features and functions described in connection with the first and second aspect of the invention applies equally to the other aspects of the invention and vice versa.

### BRIEF DESCRIPTION OF THE DRAWINGS

FIG. 1 shows a decentralized network, and

FIG. 2 shows a partly decentralized network.

### DETAILED DESCRIPTION OF THE DRAWINGS

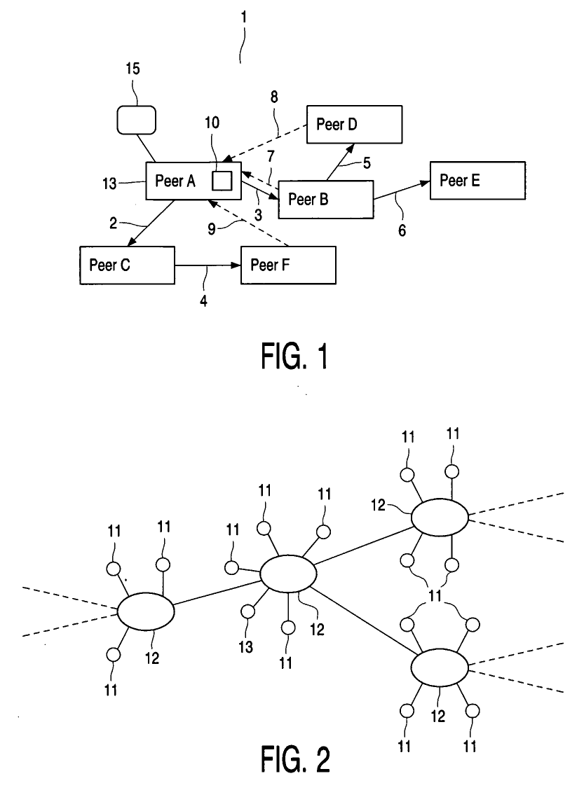

FIG. 1 shows a decentralized network 1, comprising a number of entities. The first or requesting entity 13, peer A, sends a query, 2, 3, to a number of other entities 11 of the network, that is peer B, and peer C. The peers B and C are the peers known to peer A, and peer B is then forwarding the request to the peers known to B, that is to peer D, 5, and peer E, 6; Peer C is forwarding the request to peer F, 4. The requests are indicated by solid arrows.

The request is now processed in each of the peers B, C, D, E, and F, and it is seen that the peer C did not find any match, so that no response is send from peer C to peer A. Likewise no respond is sent from peer E. It is seen that both peer D, peer E and peer F have found a match satisfying the query and are sending a response to peer A, responses 7, 8, 9 indicated by the broken arrows.

Even though the responses in the drawing are shown to be sent directly from the peer having found a match to the requesting peer, it is envisaged that the result also may be provided to the requesting peer via the same route the query came. Hereby, the response sent by peer F would be sent to peer C who will forward the response to peer A.

The receipt of the responses may be in any order, so that the response from peer F may be received by the requesting peer A, before the response from peer B is received, etc.

The responses are received by a processor 10 of peer A, and the results are presented to the user at user interface means 15 which may comprise a screen.

As an example of the method of the invention, the following situation is set up, including some more responses than shown in FIG. 1:

Peer A sends a query,

Peer B sends a response which is received at peer A 2 seconds after sending the query,

Peer F sends a response which is received at peer A 5 seconds after sending the query, relative response time is (5−2)=3 seconds,

Peer D sends a response which is received at peer A 6 seconds after sending the query, relative response time is (6−5)=1 second,

Peer G sends a response which is received at peer A 11 seconds after sending the query, relative response time is (11−6)=5 seconds,

Peer H sends a response which is received at peer A 19 seconds after sending the query, relative response time is (19−11)=8 seconds.

Saying that the initial group of responses comprises the first 3 responses and that the initial response time is the mean response time, the initial relative response time is calculated as (5−2)+(6−5)/2=2 seconds.

The current relative response time is in this case defined as the relative response time of each subsequent incoming response, and the relative-response-time parameter, the rate_change parameter, we define in this example as 3 times the initial relative response time. So we wait till the current relative response time becomes larger than 3 times the initial relative response time, i.e. 3*2 seconds=6 seconds before results are presented to a user.

Thus, the difference between the initial relative response rate and the current relative response rate is compared to the relative-response-time parameter for each further received result:

The result sent from peer G has a current relative response time of 5 seconds being below the rate_change parameter, and no results are presented to the user.

The result sent from peer H has a current relative response time of 8 seconds, being above the rate_change parameter. So 6 seconds after receiving the response from peer G all received results, that is the results received from peers B, D, F, and G are presented to the user. The 6 seconds is the time corresponding to the rate_change parameter, after receiving the response from peer G. It is known that the relative response time of any further incoming responses will be too large in relation to the rate_change parameter, and the results are therefore presented to the user without waiting for any further responses.

Regardless of the results received, the results will be presented to the user after a maximum time. In the above example, if the maximum time is set to 10 seconds, the results will be presented to the user after 10 seconds without waiting for the response from peer G. The responses from Peer G and H may then be presented to the user e.g. upon activating a refresh function of the user interfacing means.

By using the maximum time feature, long waiting times may be avoided in the case where results keep coming in at a steady rate. Usually, the max_time will be set to about 1 minute.

The results may be presented rated according to relevance, in alphabetic order, according to age of e.g. songs, according to year of recording of a film, alphabetic order according to title, according to performer, according to producer or director, or in any other convenient way with respect to the specific query.

It is envisaged that the network according to the invention does not need to be a completely decentralized network but may be any at least partly decentralized network. An example of such a partly decentralized network is seen in FIG. 2 wherein a number of peers 11 are connected to a number of peers 12 caching information about their neighbouring peers so that the do possess some server functionalities, and these peers 12 do again form a decentralized network.

Preferably, the peers may have processors of their own so that at least some of them may perform the method of the invention.

1. A method of enabling to obtain a query result in a data network (1) comprising a number of entities, the method comprises the steps of:
ending a query from a requesting entity (13) to a number of further entities (11) in the data network,
receiving responses from at least some of the number of further entities and determining an initial relative response time for an initial group of said responses,
determining a current relative response time for further incoming responses,
comparing the initial relative response time with the current relative response time, and
enabling to present the responses to a user of the requesting entity when the difference between the initial relative response time and the current relative response time exceeds a relative-response-time parameter.

2. A method according to claim 1, wherein the relative-response-time parameter is a function of the initial relative response time.

3. A method according to claim 1, wherein the relative response time is the response time of a response relative to the response time of a subsequent response.

4. A method according to claim 1, wherein the initial group of responses comprises a number of the responses first received at the requesting entity or a number of responses received at the requesting entity within a first time interval.

5. A method according to claim 1, wherein the initial relative response time is determined as the mean relative response time in the initial group of responses.

6. A method according to claim 1, the method further comprises the step of providing the results to a user when a maximum time has lapsed irrespective of the current relative response time.

7. A method according to claim 1, wherein the data network is a peer-to-peer network.

8. A method according to claim 1, wherein the maximum time and/or the relative-response-time parameter is/are set or re-set by a user of the requesting entity.

9. A method according to claim 1, wherein the received results are ordered according to a parameter before they are presented to the user.

10. A method according to claim 9, wherein the parameter is relevance or alphabetic order.

11. A method according to claim 1, wherein refreshing of the presented results shows additional results received after the initial presentation of the results to the user.

12. A method according to claim 1, wherein processing of received results is stopped upon receiving a stop signal from the user.

13. A method according to claim 12, wherein the stop signal is the initiation of a new query.

14. A method according to claim 1, wherein the query is a search query.

15. A method of providing a query response to a user, wherein the user of a requesting entity (13) sends a query to a number of entities connected in an at least partly decentralized network (1), the method comprising:
receiving responses (7, 8, 9) from at least some of the number of entities and determining an initial relative response time for an initial group of said responses,
determining a current relative response time for further incoming responses,
comparing the initial relative response time with the current relative response time, and
enabling to present the responses to a user of the requesting entity (13) when the difference between the initial relative response time and the current relative response time exceeds a relative-response-time parameter.

16. A computer readable medium having stored therein instructions for causing a central processing unit (10) to execute the method of claim 1.

17. A data network comprising a number of entities (11, 13) wherein a query is sent from a requesting entity (13) to a number further entities (11) in the network system, and wherein responses from at least some of the number of further entities are provided to a processor (10) of the requesting entity, the processor being adapted to receive the responses, and to
determine an initial relative response time for an initial group of said responses,
determine a current relative response time for further incoming responses,
compare the initial relative response time with the current relative response time, and provide the responses to a user interface means of the requesting entity for presentation of the results when the difference between the initial relative response time and the relative response time exceeds a relative-response-time parameter.

18. A data network according to claim 17, wherein the data network is an at least partly decentralized network, such as a peer-to-peer network of hard disk recorders.

19. A device for use in a method of enabling to obtain a query result in a data network comprising a number of entities (11), wherein:
the method comprises the steps of:
sending a query (2, 3) from a requesting entity to a number of further entities in the data network,
receiving responses from at least some of the number of further entities and determining an initial relative response time for an intial group of said responses,
determining a current relative response time for further incoming responses,
comparing the initial relative response time with the current relative response time, and
enabling to present the responses to a user of the requesting entity when the difference between the initial relative response time and the current relative response time exceeds a relative-response-time parameter, and
the device comprises:
a requesting entity (13) comprising a processor (10),
a number of further entities (11), the requesting entity and the number of further entities are arranged for connecting in a network, and
a user interface means (15) for presenting the responses to the user.
